(19) United States
(12) Patent Application Publication
(10) Pub. No.: US 2006/0040238 A1
(43) Pub. Date: Feb. 23, 2006

(54) Method and device for marking a dental crown

(76) Inventor: Debra Z. Mannia, New Carlisle, IN (US)

Correspondence Address: BARNES & THORNBURG, 600 1ST SOURCE BANK CENTER, 100 NORTH MICHIGAN, SOUTH BEND, IN, 466011632, US

(21) Appl. No.: 10/924,333

(22) Filed: Aug. 23, 2004

(51) Int. Cl. A61C 5/08; A61C 15/00

(52) U.S. Cl. 433/218; 132/321

(57) ABSTRACT

A dental floss and a method of using and making the dental floss. The dental floss is configured to mark a dental crown wherein the dental floss comprises a fiber substrate and a coating uniformly disposed around the fiber substrate. The dental floss further comprises a dye impregnated on at least one portion of the coating, wherein the dye adheres to a surface area of the dental crown when the fiber substrate contacts the surface area. The method of marking a dental crown with dental floss comprises placing a dental crown over a prepared tooth and inserting a fiber substrate between the dental crown and an adjacent tooth. Next, the method comprises moving the fiber substrate against a surface area of the dental crown and against the adjacent tooth in order to dispose a dye from the fiber substrate to the surface area of the crown wherein the dye marks the surface area. The method of making a dental floss comprises impregnating a dye on at least one portion of a coating and uniformly applying the coating to a fiber substrate. Next, the method comprises disposing the coating on the fiber substrate wherein the dye is configured to adhere to a dental crown when the fiber substrate contacts the dental crown.

### BACKGROUND

The present disclosure relates to a method and device for marking a dental crown. In particular, the present disclosure relates to a dental floss and a method of using the dental floss which marks an indicia on a surface area of a dental crown in order to reconstruct any measurement flaw in the dental crown.

When a tooth is cracked, decayed, or damaged, a dental crown may be needed to cover the tooth wherein the dental crown is a permanent covering that fits over the original tooth. As such, dental crowns comprise dental restorations that cover and encase the tooth. Since dental crowns encase the entire visible aspect of the tooth, the dental crown in effect becomes the tooth's new outer surface. Dental crowns can be made of porcelain, gold or other metals, resin or an amalgam (a mix) of these materials.

A dentist might recommend placing a dental crown for a variety of reasons but, in general, most of these reasons will usually fall within the following basic categories: to restore a tooth to its original shape, to strengthen the tooth or to improve the cosmetic appearance with the tooth. In setting the dental crown, the dentist usually performs three steps. First, the dentist will numb the tooth to be crowned and remove the decay or damage in or around the tooth. The tooth is then resculpted via a drill to provide a fit for the dental crown. Next, an impression of the tooth is taken and sent to the dental lab where personnel fabricate custom dental crowns based on the impression taken of the existing tooth by the dentist. Then, upon receiving the dental crown from the dental lab, the dentist fits the permanent crown onto the tooth and cements the crown into place.

Often times, though, the dental lab fabricates the crown where the interproximal width is too wide with respect to adjacent teeth which prevents the crown from being fully seated over the prepared or prepped tooth. Accordingly, the dental lab produces dental crowns which sometimes do not properly fit the prepped tooth site and the adjacent tooth. The crown however needs to be seated completely to prevent bacteria and/or food from accumulating in the void area between the crown and/or adjacent teeth. This bacteria and/or food can cause decay or nerve damage or other periodontal conditions to both the tooth and the gum. As such, properly seating the crown reduces bacteria in the area to further prevent decay and gum disease while providing a comfortable fit to the user.

### SUMMARY

The present disclosure relates to a method and device for marking a dental crown. In particular, the present disclosure relates to a dental floss and a method of using the dental floss which marks an indicia on a surface area of a dental crown in order to reconstruct any measurement flaw in the dental crown.

In an embodiment, the present disclosure relates to a dental floss which is configured to mark a dental crown wherein the dental floss comprises a fiber substrate and a coating uniformly disposed around the fiber substrate. The dental floss further comprises a dye impregnated on at least one portion of the coating, wherein the dye adheres to a surface area of the dental crown when the fiber substrate contacts the surface area. Additionally, the dye is adapted to leave an indicia on the dental crown.

In another embodiment, the present disclosure relates to a method of marking the dental crown with the dental floss. The method of marking comprises placing a dental crown over a tooth and inserting a fiber substrate between the dental crown and an adjacent tooth. Next, the user moves the fiber substrate against a surface area of the dental crown which disposes a dye from the fiber substrate to the surface area of the crown. The dye marks the surface area so the user can then reconstruct the surface area based on the dye.

In another embodiment, the present disclosure relates to a method of making the dental floss. The method of making the dental floss comprises impregnating a dye on at least one portion of a coating and uniformly applying the coating to a fiber substrate. Next, the method comprises disposing the coating on the fiber substrate wherein the dye is configured to adhere to a dental crown when the fiber substrate contacts the dental crown.

### BRIEF DESCRIPTION OF THE DRAWINGS

The detailed description particularly refers to the accompanying figures in which:

FIG. 1 is a partial side elevational view illustrating dental floss having a coating in accordance with an embodiment of the present disclosure;

FIG. 2 is a side elevational view illustrating a dental crown placed over a tooth situated between other teeth;

FIG. 3 is a side elevational view illustrating the dental floss of FIG. 1 positioned between the crown and one of the teeth of FIG. 2;

FIG. 4 is a side elevational view of the crown of FIG. 3 removed from the tooth illustrating a dye indicia in accordance with the present disclosure;

FIG. 5 is a side elevational view of the crown of FIG. 4 being processed in accordance with the present disclosure; and

FIG. 6 is a side elevational view of the crown of FIG. 5 situated between other teeth; and

FIG. 7 illustrates a flowchart for manufacturing the dental floss of FIG. 1 in accordance with an embodiment of the present disclosure.

### DETAILED DESCRIPTION

FIG. 1 illustrates in a side elevational view an embodiment of the present disclosure comprising a dental floss generally shown as 10. The dental floss 10 comprises a fiber substrate 12 and a coating 14 wherein the coating 14 uniformly disposes around the fiber substrate 12. The dental floss 10 further comprises a dye 16 impregnating at least one portion 18 of the coating 14, wherein the dye 16 may uniformly cover the at least one portion 18. In an embodiment, the at least one portion 18 uniformly covers the entire coating 14.

The fiber substrate 12 of the present disclosure may be in the form of a monofilament or in the form of a yarn comprising a plurality of such monofilaments known as a multi-filament yarn. The fiber substrate 12 in the form of the monofilament yarn may be circular or rectangular in cross section. A monofilament substrate in rectangular form typically has a width ranging from about 1.5 mm to 3 mm, a thickness ranging from about 0.02 mm to about 0.06 mm, and a denier ranging from about 600 to about 1800. The fiber substrate 12 in the form of a multi-filament yarn is typically generally circular in cross section and typically has a denier ranging from about 400 to about 1400. The denier of the individual fibers typically ranges from about 1 to about 6, although other deniers may be used if desired.

The fiber substrate 12 may also comprise a pseudo-monofilament yarn. Pseudo-monofilament yarns are made by extruding bi-component fibers typically having a core of one polymer and a sheath of a different polymer, then either partially or totally melting the sheaths of the fibers to bond or fuse the fibers, resulting in a monofilament appearance and feel. Other materials besides nylon can be used for the core of the bicomponent fibers and other polymeric materials besides polyether/amide copolymer may be used as the sheath material.

When the fiber substrate 12 comprises a monofilament or a multifilament yarn, the yarns may be made of material such as but not limited to nylon 6-6, nylon 6, polypropylene, polyethylene, polyester, polytetrafluoroethylene, and other like materials. The fiber substrate 12 may comprise a combination of the materials which are acceptable so long as the combination provides the dental floss 10 with the strength and fray resistance needed during a flossing procedure. The individual monofilaments comprising a multifilament yarn may, if desired, be air entangled. As is known in the art, the finished floss may be twisted. As a general rule, a finished twisted dental floss 10 would have from about 1 to about 6 turns per 2.54 cm.

In the case of a multifilament fiber substrate 12, the coating 14 serves to adhere the filaments together to prevent fraying and shredding of the floss 10 during use. The coating 14 may also be pliable at room temperature such that when used, the coating 14 easily displaces the fiber substrate 12 between the teeth. Preferably, an insoluble coating 14 is used on a multifilament floss to hold the filaments together and to avoid dissolution of the coating 14 in the saliva encountered in the oral cavity. Suitable insoluble coatings 14 include, but are not limited to, microcrystalline wax, beeswax, paraffin waxes, and low molecular weight polyethylene. In an embodiment, however, the coating 14 may be soluble.

Composition for the coating 14 in the present disclosure must reliably adhere the dye 16 to the surface of the floss 10, whether the fiber substrate 12 is a multifilament, monofilament, or pseudo-monofilament yarn. The coating 14 must have sufficient adherence to keep the dye 16 on the surface of the floss 10 during coating, winding, shipping and unwinding of the floss 10.

Composition for the dye 16 for use in the present disclosure must reliably adhere to dye 16 to a dental crown 20 (FIG. 2). As such, the dye 16 is adapted to transpose from the floss 10 to the dental crown 20. Accordingly, the dye 16 is adapted to adhere to the material comprising the dental crown 20 such as but not limited to the metals, porcelain, and resin used in the fabrication of the dental crown 20. Additionally, the dye 16 is adapted to adhere to the dental crown 20 while exposed to liquids such as water and saliva that exists during use of the floss 10. As the dentist uses the floss 10, the dye 16 adheres to the dental crown 20 to provide an indicia for the dentist as will be discussed.

Turning to FIG. 2, a plurality of teeth 22 are shown in a natural position within a gum line 24. Each tooth 22 includes a root 26, sides 28, top 30 (referred to as a crown) and enamel body 32 which includes a width 34 and a height 36. As shown, the side 28 of one tooth 22 contacts or is substantially adjacent to the side 28 of the adjacent tooth 22 at an interproximal area 40. The root 26 of each tooth 22 inserts into the gum 20 while the substantially uniform height 36 of each tooth 22 disposes the respective tops 30 of each tooth 22 in a substantially planar or flush position with respect to each other. A deformed tooth 38, though, does not uniformly match the sides 28 and/or top 30 with the adjacent teeth 22. Accordingly, the deformed tooth 38 requires the dental crown 20 as will be discussed.

A deformed tooth 38 may occur as a result of improper growth, decay or a blow resulting in a tooth chip. During dental treatment of the deformed tooth 38, the dentist will numb the deformed tooth 38 and remove the decay or rework any irregular shaped portion. The dentist then re-sculpts or machines the now prepared deformed tooth 38 to provide a fit for the dental crown 20. Next, the dentist makes an impression of the prepared tooth 38 and the adjacent teeth 22 and sends the impression to a dental lab. The dental lab personnel then take measurements of the impression to create the appropriate dental crown 20. Upon receiving the dental crown 20 from the dental lab, the dentist removes any temporarily covering from the deformed tooth 38 and fits the dental crown 20 onto the prepared deformed tooth 38.

A shown in FIG. 2, however, the dental crown 20 may not properly fit over the prepared tooth 38 since the dental lab may make improper measurements based on the impression. As a result, the width 34 of the dental crown 20 may be too large for the interproximal areas 40 preventing the dental crown 20 from properly seating over the prepared tooth 38. The improper fit of the dental crown 20 positions the top 42 of the dental crown 20 above the tops 26 of the other teeth 22. The dental crown 20, however, needs to be properly seated to prevent bacteria or food accumulating in the void between the dental crown 20 and the prepared tooth 38. As such, if the interproximal contact of the dental crown 20 is too tight based on an improperly formed dental crown 20, periodontal conditions and decay or nerve damage can occur.

As illustrated in FIG. 2, the width 35 of dental crown 20 presents a surface area 44 which extends beyond the crown 20 and into the interproximal area 40 to contact the adjacent tooth 22. By contacting the adjacent tooth 22, the surface area 44 prevents the dental crown 20 from properly seating on the prepared tooth 38 resulting in the top 42 positioned above the other tops 30 of the adjacent teeth 22.

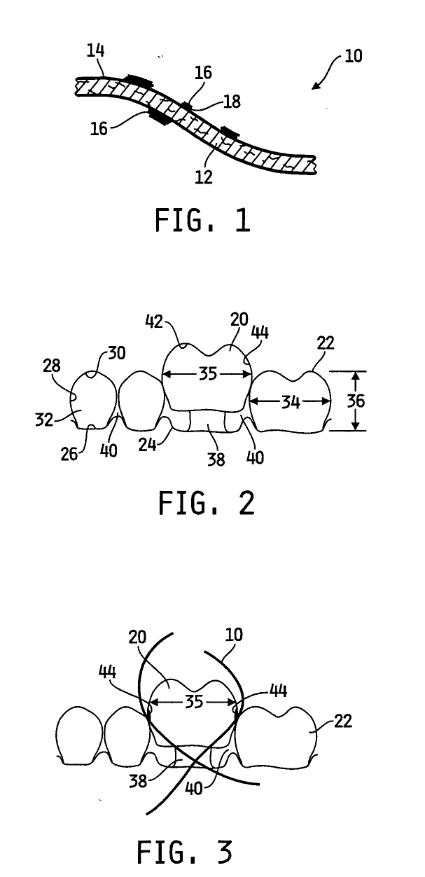

Turning to FIG. 3, the dental floss 10 of the present disclosure is adapted to fit between the prepared tooth 38 and the adjacent tooth 22. During use, the dentist inserts and reciprocates the dental floss 10 between the prepared tooth 38 and the adjacent tooth 22. Since the width 35 of the dental crown 20 extends beyond the interproximal area 40, the surface area 44 contacts the adjacent tooth 22. As such, the surface area 44 prevents the dental floss 10 from passing below the dental crown 20 to contact the gum 20 unless forced by the dentist.

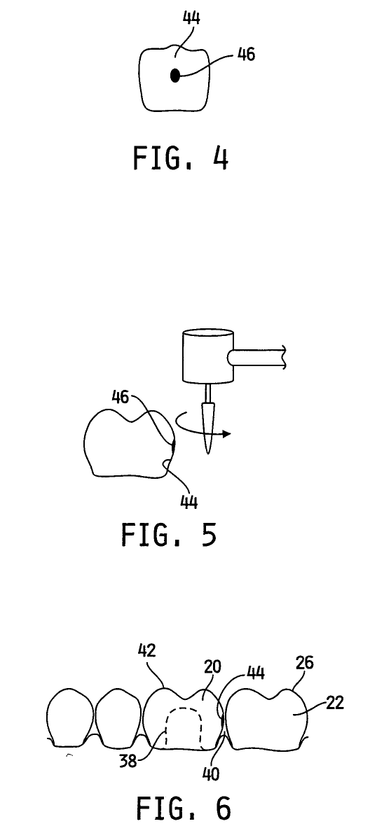

When the floss 10 contacts the surface area 44, the dye 16 adheres to the surface area 44 to leave an indicia 46 on the surface area 44 as shown in FIG. 4. The indicia 46 serves as a mark to indicate the location of the surface area 44 that requires reconstruction based on the improper measurement of the dental crown 20. Returning to FIG. 3, after adhering the dye 16 to leave the indicia 46, the dentist removes the floss 10 from the interproximal area 40 and reinserts a new portion of the floss 10 on an opposite surface area 44 to repeat the process of placing another indicia 46 (FIG. 4) on the opposite surface area 44.

It should be known that the surface area 44 may comprise more than one non-uniform area that extends away from the dental crown 20 and into the interproximal area 40. In applying the dye 16 to other surface areas 44 which require marking, the dentist may simply extend another portion of the floss 10 when the dye 16 uniformly covers the coating 14 of the fiber substrate 12. In this embodiment, the uniform covering of the dye 16 allows the dentist to continue flossing without having to look at the floss 10 during use since any portion of the floss 10 will adhere the dye 16 to the appropriate surface area 44. In an embodiment, when the dye 16 covers at least one portion 18 of the coating 14, the dye 16 may be spaced along the coating 14 to allow the dentist to apply the dye 16 to the appropriate surface area 44 while allowing other portions of the floss 10 to contact the dental crown 20 without leaving any indicia 46 since the other portions of the coating 14 may remain free from the dye 16. Additionally, when the dye 16 covers at least one portion 18 of the coating 14 in a spaced relationship, the portion of the coating 14 free from dye 16 may contact the dentist or contact the dentist's clothes without leaving any dye 16 on the dentist or the clothes.

Turning to FIG. 5, the dentist then removes the dental crown 20 (FIG. 3) having the indicia 46 from the prepared deformed tooth 38 (FIG. 3) for further processing. In an embodiment, the dentist may re-sculpt or reconstruct the dental crown 20 by machining the surface area 44 as denoted by the indicia 46. Since the dye 16 displays the indicia 46 on the surface area 44, the dentist can re-sculpt the dental crown 20 to properly fit in the interproximal area 40 by processing the surface area 44 marked by the indicia 46.

Turning to FIG. 6, after re-sculpting the dental crown 20, the dentist seats the dental crown 20 over the prepared tooth 38. Since the surface area 44 was re-sculpted, the processed surface area 44 fits within the interproximal area 40. With the dental crown 20 properly seated over the prepared tooth 38, the interproximal area 40, in an embodiment, may space the processed surface area 44 from the adjacent tooth 22. In an embodiment, the processed surface area 44 may abut against the adjacent tooth 22. Regardless of the position of the processed surface area 44 within the interproximal area 40, the height 36 of the properly seated dental crown 20 positions the top 42 of the dental crown 20 substantially planar or flush with the tops 30 of the other teeth 22 for a comfortable and properly seated fit.

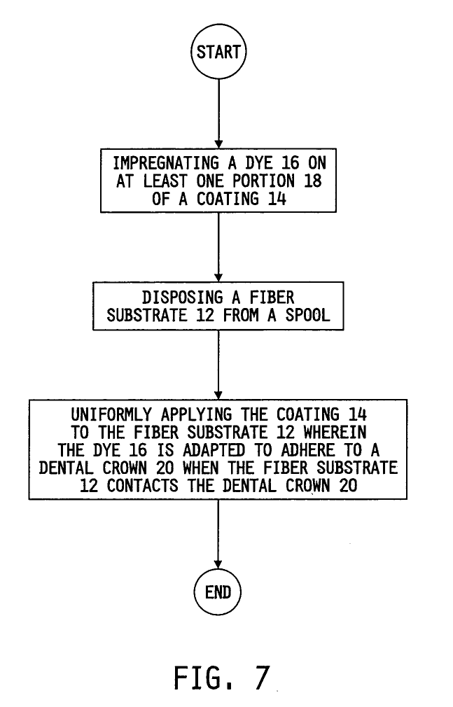

Turning to FIG. 7, a flowchart illustrates steps for making the dental floss 10 of the present disclosure. The compositions for the coating 14 and dye 16 are separated into containers wherein the composition comprising the coating 14 is liquefied if necessary, as by heating, and added to a mix tank. The dye 16 is added slowly to the liquefied ingredients of the coating 14 positioned in the mix tank while being stirred with a mixer to uniformly disperse into the coating 14.

Once the dye 16 has been uniformly mixed into the coating 14, the coating 14 is kept uniformly mixed by a slower moving mixer. This speed is sufficient to keep dye 16 in suspension, but not so fast as to stir air into the mixture. The mixture of the coating 14 and dye 16 flows into a positive displacement pump which, when driven at a given speed, delivers a constant amount of coating 14 impregnated with the dye 16 uniformly dispersed over the fiber substance 12. No matter what type of pump is used, it is necessary to keep the dye 16 in the coating 14 from settling out. This can be accomplished by keeping the flow velocities of the coating 14 sufficiently high to keep the materials in suspension or by providing agitation of the mixture through stirring or vibration.

The fiber substrate 12 is pulled off the end of a supply spool, and passes over a wheel, which drives a pulse counter. The fiber substrate 12 is pulled through the process by rewinding performed by a take-up spool. A controller such as a computer, programmable logic controller or similar device communicates with the pulse counter and modulates the speed of the take-up spool to maintain constant velocity of the fiber substrate 12. The controller also controls the speed of positive displacement pump. Thus, the speed of the fiber substrate 12 is maintained while a constant amount of coating 14 is applied onto the fiber substance 12.

The system may contain at least two rollers, wherein the rollers assist in applying the coating 14 to the fiber substrate 12 as well as work the coating 14 in between fibers (where multi-filament yarns are being utilized). Downstream of the rollers there is a slot die region where the coating 14 is smoothed onto the surface of the floss substrate 12.

The coating 14 applied to the fibrous substrate is then solidified. Solidification can be accomplished by having an open area where the coating 14 cools under ambient conditions or by use of a chamber where refrigerated or room air is blown over the floss to increase the rate of cooling. Once the coating 14 is cooled sufficiently to prevent any disruption of the outer surface, it is rewound on a standard rewind mechanism. This mechanism holds a core on a chuck, which is rotated as an eyelet is traversed back and forth along its length.

In an embodiment, the dye 16 may not be uniformly mixed with the coating 14. In this embodiment, the dye 16 remains in a separate container wherein the container applies the dye 16 on at least one portion 18 of the coating 14 prior to when the coating 14 is applied to the floss substrate 12 by the rollers. Accordingly, in this embodiment, the dye 16 may not uniformly cover the coating 14, but instead cover the at least one portion 18 of the coating. After the dye 16 is applied to the at least one portion 18 of the coating 14, the coating 14 is applied to the fiber substrate 12 and solidified as previously discussed. Still further, in an embodiment, the dye 16 may be applied to the at least one portion 18 of the coating 14 after the coating 14 has been applied and solidified on the fiber substrate 12. In this embodiment the dye 16 may uniformly cover the at least one portion 18.

Additionally, while the concepts of the present disclosure have been illustrated and described in detail in the drawings and foregoing description, such an illustration and description is to be considered as exemplary and not restrictive in character, it being understood that only the illustrative embodiments have been shown and described and that all changes and modifications that come within the spirit of the disclosure are desired to be protected by the following claims.

1. A dental floss configured to mark a dental crown, comprising:
a fiber substrate;
a coating uniformly disposed around the fiber substrate; and
a dye impregnated on at least one portion of the coating wherein the dye adheres to a surface area of the dental crown when the fiber substrate contacts the surface area.

2. The dental floss according to claim 1, wherein the fiber substrate is a monofilament.

3. The dental floss according to claim 1, wherein the fiber substrate is a multifilament.

4. The dental floss according to claim 1, wherein the coating is insoluble.

5. The dental floss embodiment to claim 1, wherein the at least one portion of the coating uniformly covers the coating.

6. The dental floss according to claim 1, wherein the dye is impregnated uniformly around the at least one portion of the coating.

7. The dental floss according to claim 1, wherein the dye is adapted to leave an indicia when adhering to the dental crown.

8. The dental floss according to claim 7, wherein the indicia is adapted to remain on the dental crown when the dental crown is removed.

9. A method of marking a dental crown with dental floss comprising:
placing a dental crown over a tooth;
inserting a fiber substrate between the dental crown and an adjacent tooth;
moving the fiber substrate against a surface area of the dental crown; and
disposing a dye from the fiber substrate to the surface area of the crown wherein the dye marks the surface area.

10. The method of marking a crown according to claim 9, wherein placing the crown over the tooth comprises positioning a top of the crown above a top of the adjacent tooth.

11. The method of marking a crown according to claim 9, further comprising removing the dental crown containing the disposed dye.

12. The method of marking a crown according to claim 11, further comprising reconstructing the surface area after removing the dental crown.

13. The method of marking a crown according to claim 12, wherein reconstructing the surface area comprises machining the surface area containing the disposed dye.

14. The method of marking a crown according to claim 13, further comprising setting the dental crown over the tooth after machining portions of the surface area.

15. The method of marking a crown according to claim 14, wherein setting the dental crown over the tooth comprises positioning a top of the crown planar with a top of the adjacent tooth.

16. A method of making dental floss, comprising:
impregnating a dye on at least one portion of a coating; and
uniformly applying the coating to a fiber substrate wherein the dye is adapted to adhere to a dental crown when the fiber substrate contacts the dental crown.

17. The method of manufacturing according to claim 16, wherein impregnating the dye on the at least one portion comprises uniformly covering the coating.

18. The method of manufacturing according to claim 16, wherein impregnating the dye on the at least one portion comprises uniformly coating the at least one portion.
